(19) United States
(12) Patent Application Publication
(10) Pub. No.: US 2015/0261968 A1
(43) Pub. Date: Sep. 17, 2015

(54) VISUALIZING RANDOM CHARACTERS FOR KEYBOARD-LESS DEVICES

(71) Applicant: MAXIM POLYACHENKO, Rishon LeZion (IL)

(72) Inventor: MAXIM POLYACHENKO, Rishon LeZion (IL)

(73) Assignee: EBAY INC., SAN JOSE, CA (US)

(21) Appl. No.: 14/207,369

(22) Filed: Mar. 12, 2014

(51) Int. Cl. G06F 21/60; G06F 3/0488

(52) U.S. Cl. CPC G06F 21/604; G06F 3/04886

(57) ABSTRACT

In various example embodiments, a system and method are provided for visualizing a set of random characters which may be used to communicate private user information by voice input to a client device. In example embodiments, a request to communicate private user information is received from a client device. In response to the request, a set of random characters is generated, and at least one random character from the set of random characters corresponds to a character from a set of standard characters. An image with the set of standard characters and the set of random characters may be created and displayed on the client device. The client device may be a wearable device in example embodiments.

### TECHNICAL FIELD

Embodiments of the present disclosure relate generally to image processing, and more particularly, but not by way of limitation, to visualizing a set of random characters for providing voice input for private user information.

### BACKGROUND

Many wearable devices are keyboard-less devices. Wearable devices, such as Google Glass™ (developed by Google Inc, of Mountain View, Calif.), do not have keyboards and may allow the user to use natural language spoken into a microphone and gestures on a touchpad to provide user input. In certain environments or situations, a user may want to provide identification information, including user name and password, to access an app running on the wearable device. Often, the user considers this information private and does not want to share this identification information with others, who may be close enough to a user to hear the user's voice input. As a result, users may be hesitant to provide voice input to a wearable device.

### BRIEF DESCRIPTION OF THE DRAWINGS

Various ones of the appended drawings merely illustrate example embodiments of the present disclosure and cannot be considered as limiting its scope.

FIG. 1 is a block diagram of a networked system depicting an example embodiment.

FIG. 2 is a block diagram depicting at example embodiment of a publication system.

FIG. 3 is a block, diagram illustrating an example embodiment of a random character visualization engine.

FIG. 4 is a flow diagram for visualizing a set of random characters in accordance with an example embodiment.

FIG. 5 is a flow diagram using voice input to provide private user information in accordance with an example embodiment.

FIG. 6A is a table mapping standard characters displayed to random characters displayed, and mapping random characters displayed to random characters spoken, according to an example embodiment.

FIG. 69 is an image of a keyboard displaying a standard set of characters and selected random characters, according to an example embodiment.

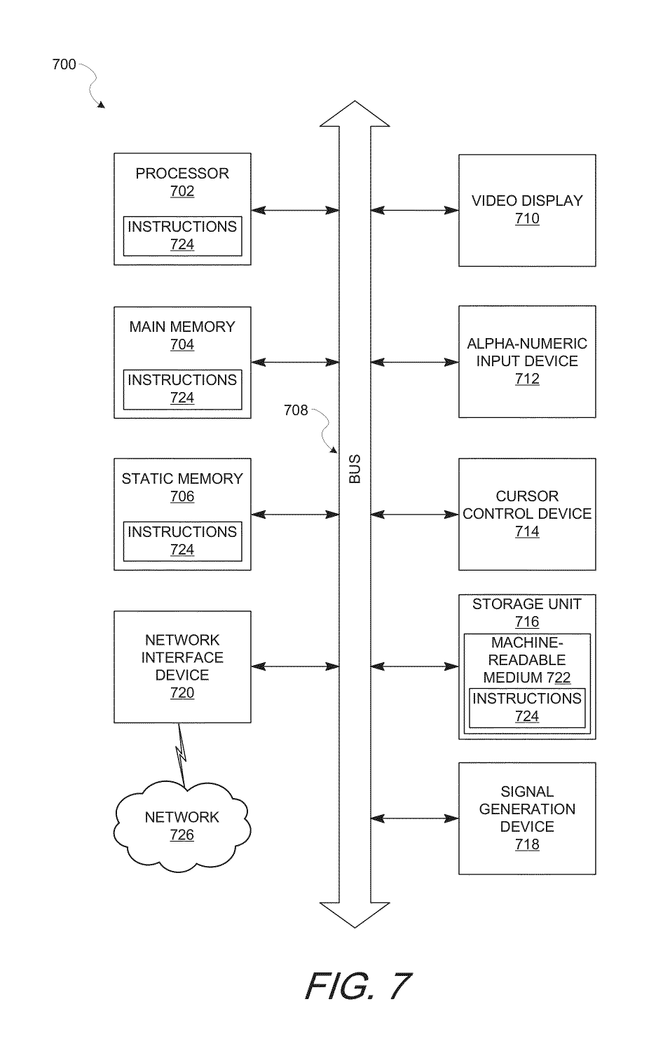

FIG. 7 is an example embodiment of a computer system in conjunction with the present inventive subject matter.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

As used herein, the term “or” may be construed in either an inclusive or exclusive sense. Additionally, although various example embodiments discussed below focus on a marketplace environment, the embodiments are given merely for clarity in disclosure. Thus, any type of electronic publication, electronic commerce, social networking, or electronic business system and method, including various system architectures, may employ various embodiments of the system and method described herein and may be considered as being within a scope of example embodiments. Each of a variety of example embodiments is discussed in detail below.

Example embodiments described herein provide systems and methods for visualizing a set of random characters and using voice input to provide private user information into a keyboard-less device. Private user information may include financial information, identification information, and other information that users would like to keep private. For example, a user located in a public location would like to use voice input to input data into a keyboard-less device in a private manner, even if the user's voice input is audible to others. In other words, the user may provide natural language voice input in which the content of the private user information is not recognizable by others even if they can hear what the user is saying. For example, a user may want to log into one of the user's online banking accounts or online payment accounts, such as a PayPal® account, by speaking characters which are randomly generated such that others who can hear the user cannot understand the content of the private user information.

For example embodiments, a user may request to communicate private user information by speaking random characters which are displayed on user's keyboard-less device, such as a wearable computing device like a Google Glass or a smart watch. In some embodiments, a set of random characters is generated, where at least one random character corresponds to a standard character from a set of standard characters. For an example embodiment, the set of standard characters represents characters on a computer keyboard, including letters, numbers or digits, signs, symbols, colors, special characters and/or images. The randomly generated characters and their corresponding standard characters are presented to the user on the user's keyboard-less device.

For one embodiment, an image of a keyboard having a set of standard characters, may be augmented with random characters, and displayed to the user on a wearable computing device, like a Google Glass. In alternative embodiments, the image of the random characters mapped to standard characters may not represent an augmented reality image. In further embodiments, the user may use natural language voice input by saying random characters, to log into an application (also referred to as an “app”) accessible on the user's wearable computing device, or to input other private or sensitive information into apps accessible on the user's wearable computing device, in other embodiments, the user may use natural language voice input to navigate through the user's wearable computing device to perform various functions, commands, or actions. The standard characters corresponding to the random character voice input are recognized by the system and are used to log the user into the relevant app, perform other services or functions related to the relevant app on user's wearable computing device, or navigate through the user's wearable computing device. By saying randomly generated characters, instead of the true content characters (represented by the standard characters) the user prevents the user's private information (such as account information, username, password, sensitive information, etc) from being recognized by others who hear the user speak into the user's wearable computing device. As such, the user of a wearable computing device who uses natural language voice input may keep his or her private information confidential when randomly generated characters are used. For alternative embodiments, voice input may be used alone or in conjunction with other forms of data input such as gestures (e.g., swiping motions on a touchpad).

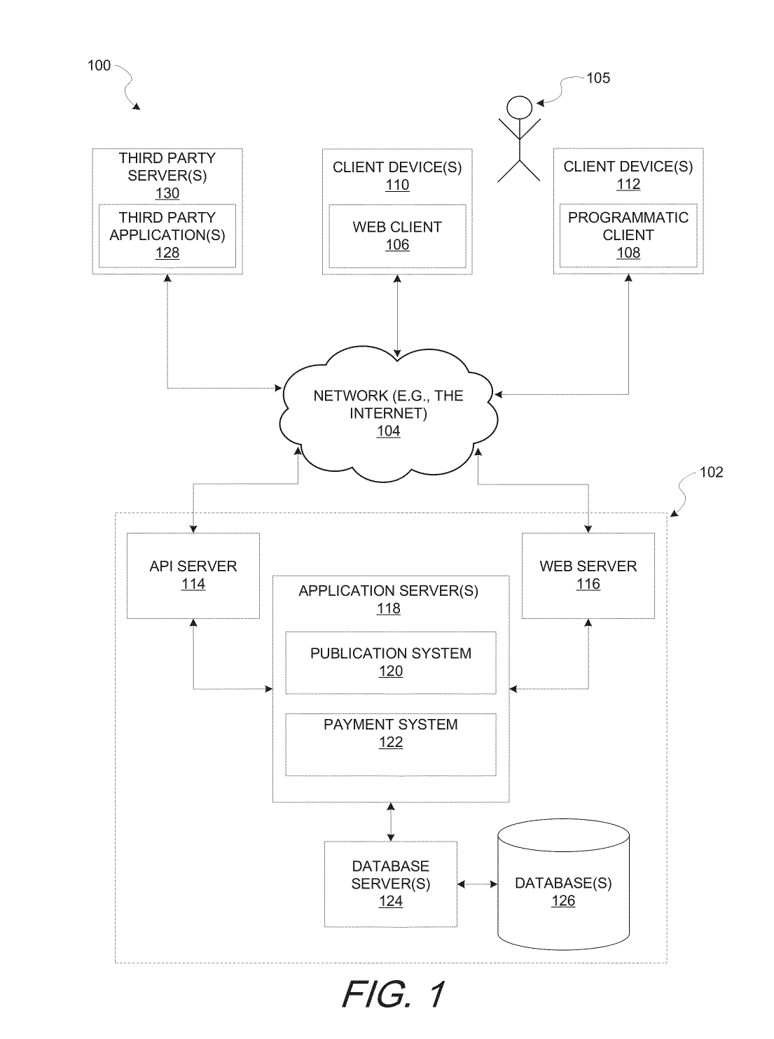

With reference to FIG. 1, an example embodiment of a high-level client-server-based network architecture 100 to enable visualization of randomly generated characters on a keyboard-less device and to communicate private user information using the random characters through voice input is shown. A networked system 102, in an example, provides network-server-side functionality, and is coupled via a communication network, (e.g., the Internet, wireless network, cellular network, or a Wide Area Network (WAN)) to one or more client devices 110 and 112. FIG. 1 illustrates, for example, a web client 106 operating via a browser (e.g., such as the INTERNET EXPLORER® browser developed by Microsoft® Corporation of Redmond, Wash. State), and a programmatic client 108 executing on respective client devices 110 and 112.

The client devices 110 and 112 may comprise a mobile phone, wearable computing device, desktop computer, laptop, or any other device that a user, such as user 105 may utilize to access the networked system 102. In various embodiments, the client devices 110 and 112 may be wearable computing devices (e.g., Google Glass or a smart watch), that is, keyboard-less, or other types of similar devices. As used herein, a keyboard-less device refers to a device without a keyboard (either physical or virtual) that has physical keys or interactive surfaces that is used for inputting data by having a user push the keys or touch the relevant portion of an interactive screen to select characters. It should be noted that client devices 110 and 112 may be capable of displaying an image of a keyboard on a screen and may receive voice input to select the characters on the keyboard image. Such devices may be considered keyboard-less within the spirit and scope of the described embodiments. In some embodiments, the client device 110 may comprise or be connectable to an image capture device such as a camera or camcorder (not shown). In further embodiments, the client devices 110 and 112 may include one or more of a touchpad, touch screen, accelerometer, microphone, and GPS device. Various applications or apps may run on the client devices 110 and 112. For example, one or more applications from a publication system 120 and a payment system 122 may be accessible to the user 105 by having a corresponding app run on the client devices 110 and 112. Alternatively, the user 105 may access such applications from the client devices 110 and 112 through a web browser. The user 105 may want to log into such applications and apps using the client devices 110 and 112, while keeping their identification information private. In example embodiments, the client devices 110 and 112 may be an individual user's device, such as user 105, who is interested in communicating private information using natural language voice input by saying randomly generated characters, which hides the content of the voice input from others who may hear the user 105 speak.

For example embodiments, client devices 110 and 112 may be any type of keyboard-less device, such as a Google Glass or smart watch. For example, Google Glass includes a touchpad and microphone for receiving user input. Voice input, such as voice commands and natural language, may be received by a microphone. Voice recognition software and/or text recognition software may be used to process the voice input (representing audible random characters), received by client devices 110 and 112, into text characters in accordance with various embodiments. The touchpad allows the user 105 to control the Google Glass using swiping motions (forward and backward) to navigate through a time-line like interface displayed on a screen.

The Google Glass may also include an optical head-mounted display (OHMD), which displays information in a hands-free format. The OHMD may provide a transparent screen to the user 105, where all the information is displayed, including the randomly generated characters used to communicate private user information. Many apps are available for Google Glass, such as (Gmail, Google maps, Google search, messaging, sharing to social networks such as Facebook® and Twitter®, online payments, etc. Such apps may specify the user 105 to log into the app with a user name and password using voice input. Google Glass may communicate via Wi-Fi or via Bluetooth to share data connections with other devices. Google Glass may be able to access various services (GPS or SMS messaging) through a Bluetooth connection with an Android® device. A camera device is attached to the glass and has the ability to take photos and record videos. By having the camera attached to the Google Glass and the screen right on top of the user's vision, the user 105 may be provided with an augmented reality image. The augmented reality image may be an image of the user's mobile device keyboard, displayed on the screen, augmented with random characters that overlay the corresponding keyboard characters.

An Application Program Interface (API) server 114 and a web server 116 are coupled to, and provide programmatic and web interfaces respectively to, one or more application servers 118. The application servers 118 may reside on server machines (not shown) that host the publication system 120 and the payment system 122, each of which may comprise one or more modules, applications, or engines, and each of which may be embodied as hardware, software, firmware, or any combination thereof. The application servers 118 are, in turn, coupled to one or more database servers 124 facilitating access to one or more information storage repositories or databases 126. The databases 126 may also store user account information of the networked system 102 in accordance with example embodiments.

The databases 126 may store data pertaining to various functions and aspects associated with the client-server-based network architecture 100 and its users. For example, user accounts for users of the networked system 102 may be stored and maintained in the databases 126. Each user account may comprise user data that describes aspects of a particular user, such as the user 105. The user data may include demographic data, user preferences, and financial information. The demographic data may, for example, include information describing one or more characteristics of user 105. Demographic data may, for example, include gender, age, location information, employment history, education history, contact information, familial relations, or user interests. The financial information may, for example, include private financial information of the user 105 such as account number, credential, password, device identifier, user name, phone number, credit card information, bank information, transaction history or other financial information which may be used to facilitate online transactions by the user 105. Consistent with some embodiments, the transaction history may include information related to transactions for goods or services (collectively referred to as “items” or “products”) that may be offered for sale by merchants using marketplace services provided by the networked system 102. The transaction history information may, for example, include a description of a product purchased by the user 105, an identifier of the product, a category to which the product belongs, a purchase price, a quantity, or a number of bids. The databases 126 may also store image data for displaying a set of random characters and a set of standard characters that are presented to the user 105.

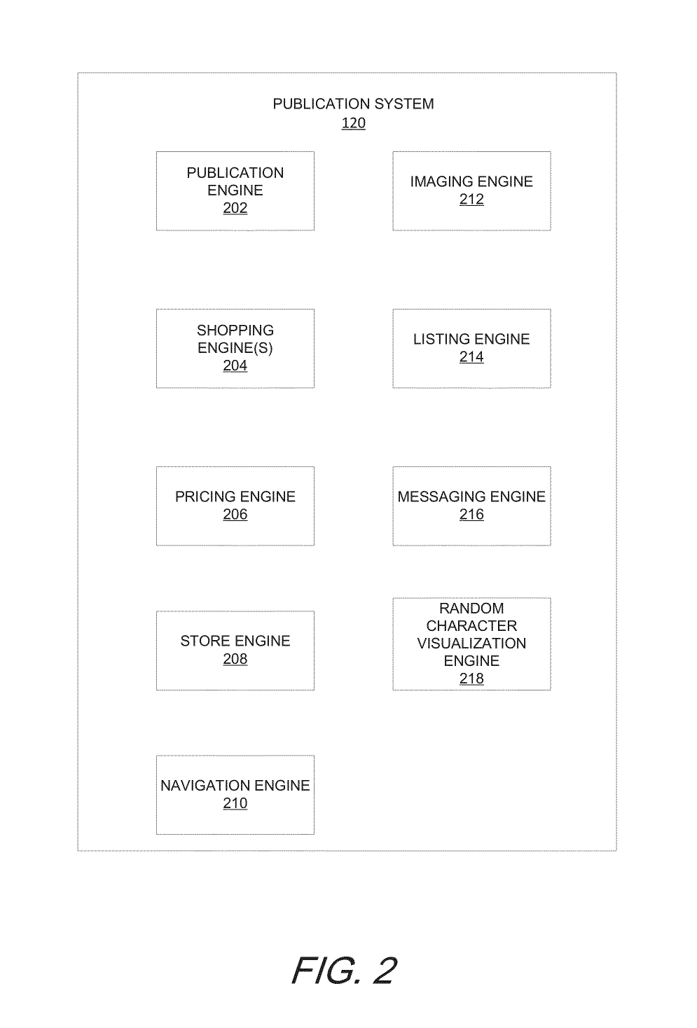

In example embodiments, the publication system 120 publishes content on a network (e.g., Internet). As such, the publication system 120 provides a number of publication functions and services to users that access the networked system 102. The publication system 120 is discussed in more detail in connection with FIG. 2. In example embodiments, the publication system 120 is discussed in terms of a marketplace environment. However, it is noted that the publication system 120 may be associated with a non-marketplace environment such as an informational or social networking environment. In various embodiments, the publication system 120 may include a random character visualization engine 218 for providing visualization of a set of random characters and using voice input to provide private user information to a keyboard-less device. For alternative embodiments, the random character visualization engine 218 (see FIG. 2) may be implemented using third party servers 130 and/or application servers 118.

The payment system 122 provides a number of payment services and functions to users. The payment system 122 allows users to accumulate value (e.g., in a commercial currency, such as the U.S. dollar, or a proprietary currency, such as “points”) in their accounts, and then later to redeem the accumulated value for products (e.g., goods or services) that are made available via the publication system 120 or elsewhere on the network 104. The payment system 122 also facilitates payments from a payment mechanism (e.g., a bank account, PayPal™, or credit card) for purchases of items via any type and form of a network-based marketplace.

While the publication system 120 and the payment ent system 122 are shown in FIG. 1 to both form part of the networked system 102, it will be appreciated that, in alternative embodiments, the payment system 122 may form part of a payment service that is separate and distinct from the networked system 102. Additionally, while the example network architecture 100 of FIG. 1 employs a client-server architecture, a skilled artisan will recognize that the present disclosure is not limited to such architecture. The example network architecture 100 can equally well find application in, for example, a distributed or peer-to-peer architecture system, n-tier architecture, or virtualized cloud computing architecture. The publication system 120 and payment system 122 may also be implemented as standalone systems or standalone software programs operating under separate hardware platforms, which do not necessarily have networking capabilities.

Additionally, a third party application(s) 128, executing on a third party server(s) 130, is shown as having programmatic access to the networked system 102 via the programmatic interface provided by the API server 114. For example, the third party application 128, utilizing information retrieved from the networked system 102, may support one or more features or functions on a website hosted by the third party. The third party website may, for example, provide one or more promotional, marketplace, or payment functions that are supported by the relevant applications of the networked system 102.

Referring now to FIG. 2, an example block diagram illustrating multiple components that, in one embodiment, are provided within the publication system 120 of the networked system 102 is shown. In one embodiment, the publication system 120 is a marketplace system where items (e.g., goods or services) may be offered for sale. In an alternative embodiment, the publication system 120 is a social networking system or informational system. The publication system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more databases 126 via the one or more database servers 124.

In one embodiment, the publication system 120 provides a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication system 120 may comprise at least one publication engine 202 and one or more shopping engines 204. In one embodiment, the shopping engines 204 may support auction-format listing and price setting mechanisms (e.g., English, Dutch, Chinese, Double, Reverse auctions, etc.).

A pricing engine 206 supports various price listing formats. One such format is a fixed-price listing format (e.g., the traditional classified advertisement-type listing or a catalog listing). Another format comprises a buyout-type listing. Buyout-type listings (e.g., the Buy-It-Now (BIN) technology developed by eBay Inc., of San Jose, Calif.) may be offered in conjunction with auction-format listings and allow a buyer to purchase goods or services, which are also being offered for sale via an auction, for a fixed price that is typically higher than a starting price of an auction for an item.

A store engine 208 allows a seller to group listings within a “virtual” store, which may be branded and otherwise personalized by and for the seller. Such a virtual store may also offer promotions, incentives, and features that are specific and personalized to the seller. In one example, the seller may offer a plurality of items as Buy-It-Now items in the virtual store, offer a plurality of items for auction, or a combination of both.

Navigation of the publication system 120 may be facilitated by a navigation engine 210. For example, a search module (not shown) of the navigation engine 210 enables, for example, keyword searches of listings or other information published via the publication system 120. In a further example, a browse module (not shown) of the navigation engine 210 allows users to browse various category, catalog, or data structures according to which listings or other information may be classified within the publication system 120. Various other navigation applications within the navigation engine 210 may be provided to supplement the searching and browsing applications. In one embodiment, the navigation engine 210 allows the user to search or browse for items in the publication system 120 (e.g., virtual stores, listings in a fixed-price or auction selling environment, listings in a social network or information system). In alternative embodiments, the navigation engine 210 may navigate (e.g., conduct a search on) a network at large (e.g., network 104).

In order to make listings or posting of information available via the networked system 102 as visually informing and attractive as possible, the publication system 120 may include an imaging engine 212 that enables users to upload images for inclusion within listings and to incorporate images within viewed listings. The imaging engine 212 may work in conjunction with the random character visualization engine 218 to generate the augmented reality image, or other image, as will be discussed in more details below.

A listing engine 214 manages listings on the publication system 120. In example embodiments, the listing engine 214 allows users to author listings of items. The listing may comprise an image of an item along with a description of the item. In one embodiment, the listings pertain to goods or services that a user (e.g., a seller) wishes to transact via the publication system 120. As such, the listing may comprise an image of a good for sale and a description of the item such as, for example, dimensions, color, and, identifier (e.g., UPC code, ISBN code). In some embodiments, a user may create a listing that is an advertisement or other form of publication to the networked system 102. The listing engine 214 also allows the users to manage such listings by providing various management features (e.g., auto-relisting, inventory level monitors, etc.).

A messaging engine 216 is responsible for the generation and delivery of messages to users of the networked system 102. Such messages include, for example, advising users regarding the status of listings and best offers (e.g., providing an acceptance notice to a buyer who made a best offer to a seller) or providing recommendations. The messaging engine 216 may utilize any one of a number of message delivery networks and platforms to deliver messages to users. For example, the messaging engine 216 may deliver electronic mail (e-mail), an instant message (IM), a Short Message Service (SMS), text, facsimile, or voice (e.g., Voice over IP (VOW)) messages via wired networks (e.g., the Internet), a Plain Old Telephone Service (POTS) network, or wireless networks (e.g., mobile, Wi-Fi, WiMAX).

A random character visualization engine 218 manages the generation and display of randomly generated characters used to communicate private user information. The random character visualization engine 218 will be discussed in more detail in connection with 3.

Although the various components of the publication system 120 have been defined in terms of a variety of individual modules and engines, a skilled artisan will recognize that many of the items can be combined or organized in other ways. Alternatively, not all components of the publication system 120 of FIG. 2 may be utilized. Furthermore, not all components of the publication system 120 have been included FIG. 2. In general, components, protocols, structures, and techniques not directly related to functions of exemplary embodiments (e.g., dispute resolution engine, loyalty promotion engine, personalization engines, etc.) have not been shown or discussed in detail. The description given herein simply provides a variety of exemplary embodiments to aid the reader in an understanding of the systems and methods used herein.

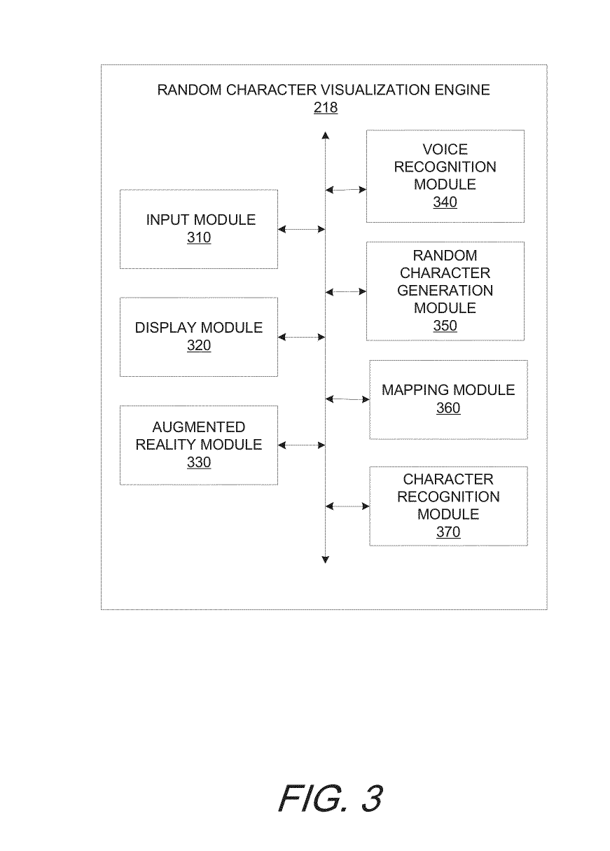

FIG. 3 is a block diagram illustrating an example embodiment of the random character visualization engine 218. In an example embodiment, the random character visualization engine 218 comprises an input module 310, a display module 320, an augmented reality module 330, a voice recognition module 340, a random character generation module 350, a mapping module 360, and a character recognition module 370. All of the modules may communicate with each other, for example, via a network coupling, shared memory, and the like. It will be appreciated that each module may be implemented as a single module, combined into other modules, or further subdivided into multiple modules. Other modules not pertinent to example embodiments may also be included, but are not shown. In alternative embodiments, one or more modules shown in the random character visualization engine 218 may not be used. For example, the augmented reality module 330 may not be included in some embodiments, where an image displayed does not use augmented reality.

In an example embodiment, the input module 310 may be configured to receive voice information or gesture information from the client devices 110 and 112. The voice information may include voice actions or commands, such as “take a picture”, “send a video”, “send a message”, or “get directions to.” Voice commands such as “display random characters”, “identification”, “log into account” or “private” may be used to request private user information to be communicated using random characters. Additionally, the voice information may include random characters spoken by the user 105. Private user information may include a variety of information types that the user 105 would like to keep private from other users, such as user names and passwords. For example, a user wearing a keyboard less wearable computing device, such as Google Glass, may be accessing applications such as PayPal. When logging into PayPal using Google Glass, rather than using voice input, to say the user name characters and password characters, a user may wish to say random characters that other third parties nearby, who may over-hear, would not recognize as the user name characters and password characters. In order to maintain the user's private user name and password as secret, random characters may be generated and displayed to the user in an augmented reality image or other image. The random characters spoken by the user may be received as input by random character visualization engine 218 through input module 310. In other embodiments, the input module 310 may be configured to receive other forms of input information, such as gestures (e.g., swiping actions on a touchpad) that may be used to communicate private user information alone or in conjunction with the voice information.

In an example embodiment, the display module 320 may be configured to provide image data to display the augmented reality image or other image on the client device 110 or 112. The image may be generated by the augmented reality module 330. For an example embodiment, the augmented reality module 330 may be configured to augment the set of standard characters with the set of random characters to create an image. By augmenting the set of standard characters with a set of randomly generated characters, the user may use their voice to speak private user information without having other users understand or recognize the content of the spoken random characters.

A set of standard characters may include characters available from standard keyboard layouts or other input devices. The characters may include letters, numbers, digits, signs, symbols, colors, special characters and/or images. The special characters may include a variety of symbols generally available for data entry by keyboards. In alternative embodiments, the special characters may include various types of images that random character visualization engine 218 may recognize thru voice recognition as corresponding to a standard character.

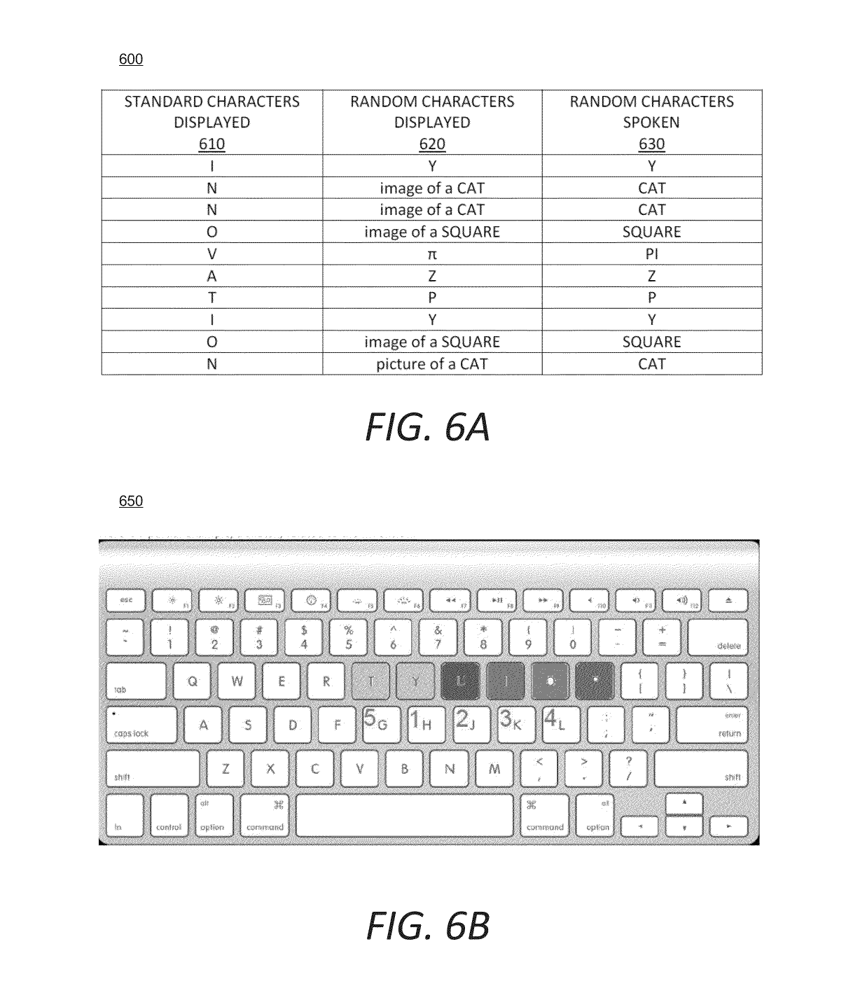

In an example embodiment, a user may have a password “INNOVATION” when spelled with standard characters. Table 600 shown in FIG. 6A illustrates the mapping for the standard characters displayed (shown in column 610) to the random characters displayed (shown in column 620) for the password “INNOVATION.” Table 600 also shows, in column 630, the characters spoken and received as voice input. The image may display to a user that the letter “I” corresponds to a random character “Y” the letter “N” may correspond to a random character illustrating a picture of a “CAT”, the letter “O” may correspond to a random character of an image of a “SQUARE”, the letter “V” may correspond to a random character “it”, the letter “A” may correspond to a letter “Z”, and the letter “T” may correspond to a letter “P”. When the user provides voice input for the password of “INNOVATION”, the user says the random characters “Y-CAT-CAT-SQUARE-π-Z-P-Y-SQUARE-CAT” as shown in column 630. In alternative embodiments, more than one random character from the set of random characters may correspond to a single standard character from the set of standard characters. For one embodiment, the standard characters for the word “INNOVATION” represent a subset of words in a set of standard characters, and the random characters associated with the word “INNOVATION” represent a subset in a set of random characters.

In another example embodiment, the image displayed may be an augmented image of a keyboard with random characters overlaying the standard characters on the keys of the keyboard. Referring now to FIG. 613, a keyboard 650 is displayed. The keyboard 650 illustrates a set of standard characters representing the characters displayed on common computer keyboard. In alternative embodiments, other types of keyboards or similar input devices may be used to display a set of standard characters. The standard characters “T” “Y” “U” “I” “O” “P” “G” “H” “I” “K” “L” on keyboard 650 and displayed on the keys of keyboard, are augmented with a variety of random characters. If a user's password is “HOTJOY”, the user may provide the following voice input by saying “ONE-BLUE-GREY-TWO-BLUE-YELLOW” and the random character visualization engine 218 will recognize this random characters (represented by digits and colors in this example) and input (via text input) the password “HOTJOY” into the relevant password field of an app running on a client device. In various embodiments, the random characters displayed on keyboard 650 are only temporarily available to ensure a high security standard. The next time a user would like to use voice input to communicate the password “HOTJOY”, the new random characters will be assigned to each character in the set of standard characters. For example, the letter “O” may get assigned a different color, than that displayed on keyboard 650.

The random characters may be displayed in a variety of ways, for example, by replacing the standard characters on the keyboard, by displaying the random characters next to its corresponding standard character, or by displaying a color on the key of a standard character. In the example shown in FIG. 613, the random characters, represented by colors and digits may be replaced with images, pictures, symbols, letters or other characters in other alternative embodiments. Although only a portion of the standard characters displayed on the keys of keyboard 650 are augmented with random characters in this example, other embodiments may augment all keys, all relevant keys or some of the keys on keyboard 650 with random characters.

In an example embodiment, the random character generation module 350 is configured to generate a set of random characters in response to the request to communicate private user information, and at least one random character from the set of random characters corresponds to a character from a set of standard characters. For various embodiments, the set of random characters corresponding to the set of standard characters is available for either a limited period of time or a specified number of requests. For example, the set of random characters may available only for a single request to communicate private user information. For one embodiment, the single request to communicate (private user information may be logging into PayPal or other application by providing user name and/or password. By providing limited availability of a particular set of random characters, it becomes more difficult for a person listening to the user speaking random characters to recognize or figure out the true content characters, as represented by the set of standard characters.

The mapping module 360 may be configured to associate the set of random characters with the set of standard characters. The mapping module 360, the random character generation module 350, and the augmented reality module 330, may be used in various embodiments, to create the augmented reality image or other image, which is displayed to a user by display module 320. In an example embodiment, voice recognition and/or text recognition technology may be incorporated into the mapping module 360 and the character recognition module 370. The mapping module 360 may be configured to map spoken random characters to corresponding characters from the set of standard characters. An example mapping for the password “INNOVATION” is shown in Table 600 in FIG. 6A. The character recognition module 370 may be configured to recognize the private user information using the corresponding characters from the set of standard characters. Once the standard characters in the private user information is recognized, the private user information may be used for its intended purpose, for example entering a password to access an app. For some embodiments, the private user information, as recognized by the character recognition module 370, may be provided to an application or app running or accessible on a client device (e.g., client devices 110 and 112).

In an example embodiment, the input module 310 is configured to receive, from a client device, a request to communicate private user information using random characters. The random character generation module 350 is configured to generate a set of random characters in response to the request to communicate private user information using random characters, and at least one random character from the set of random characters corresponds to a character from a set of standard characters. The augmented reality module 330 may be configured to augment the set of standard characters with the set of random characters to create an image. The display module 320 may be configured to provide image data to the client device to display the image.

In yet a further embodiment, the mapping module 360 may be configured to associate, using at least one processor, the set of random characters with the set of standard characters. In yet another embodiment, a voice recognition module 340 may be configured to receive, from a user, a voice command, and to convert the voice command to the request to communicate private user information using random characters.

In further embodiments, the client device does not include a keyboard like input device for receiving user input via physical keys or virtual keys. In other embodiments, the image includes the set of random characters overlaying the set of standard characters. For example, the image may include an image of a keyboard with a set of standard characters that have a set of random characters superimposed on the set of standard characters. Alternatively, the image displayed to a user, may include the set of standard characters mapped to the set of random characters in a chart like format (without using any augmented reality technology), such as the Table 600 shown in FIG. 6A.

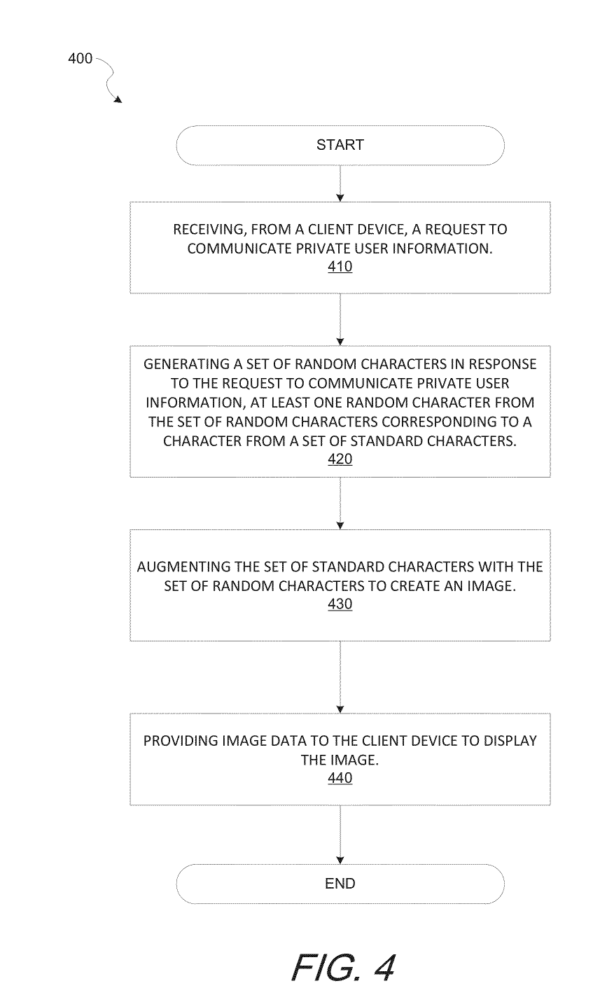

FIG. 4 is a flow diagram for visualizing a set of random characters in accordance with an example embodiment. In one embodiment, the method comprises: at operation 410, receiving, from a client device, a request to communicate private user information; at operation 420, generating a set of random characters in response to the request to communicate private user information, at least one random character from the set of random characters corresponding to a character from a set of standard characters; at operation 430, augmenting the set of standard characters with the set of random characters to create an image; and at operation 440, providing image data to the client device to display the image. For example embodiments, flow diagram 400 may be implemented using one or more modules from the random character visualization engine 218. For example, flow diagram 400 may be implemented using input module 310 at operation 410, random character generation module 350 and/or mapping module 360 at operation 420, augmented reality module 330 at operation 430, and display module 320 at operation 440.

For another embodiment, the image displays a mapping of the set of random characters to the set of standard characters. In yet another embodiment, the image displays the set of random characters overlaying the set of standard characters. In a further embodiment, augmenting the set of standard characters with the set of random characters to create an image further comprises overlaying the set of random characters over the set of standard characters displayed on a keyboard.

In other exemplary embodiments, receiving, from a client device, a request to communicate private user information, further comprises receiving, from a user, a voice action, and converting the voice action to the request to communicate private user information. Ill other embodiments, receiving, from a client device, a request to communicate private user information, further comprises receiving, from a user, a gesture command, and converting the gesture command to the request to communicate private user information.

In further embodiments, generating the set of random characters in response to the request to communicate private user information further comprises mapping the set of random characters to a set of standard characters. In other embodiments, generating the set of random characters in response to the request to communicate private user information, further comprises generating at least one random character corresponding to each one of the set of standard characters, the at least one random character representing one or more letters, digits or special symbols. In some embodiments, the set of standard characters represents characters available on a standard keyboard layout including one or more letters, digits or special symbols.

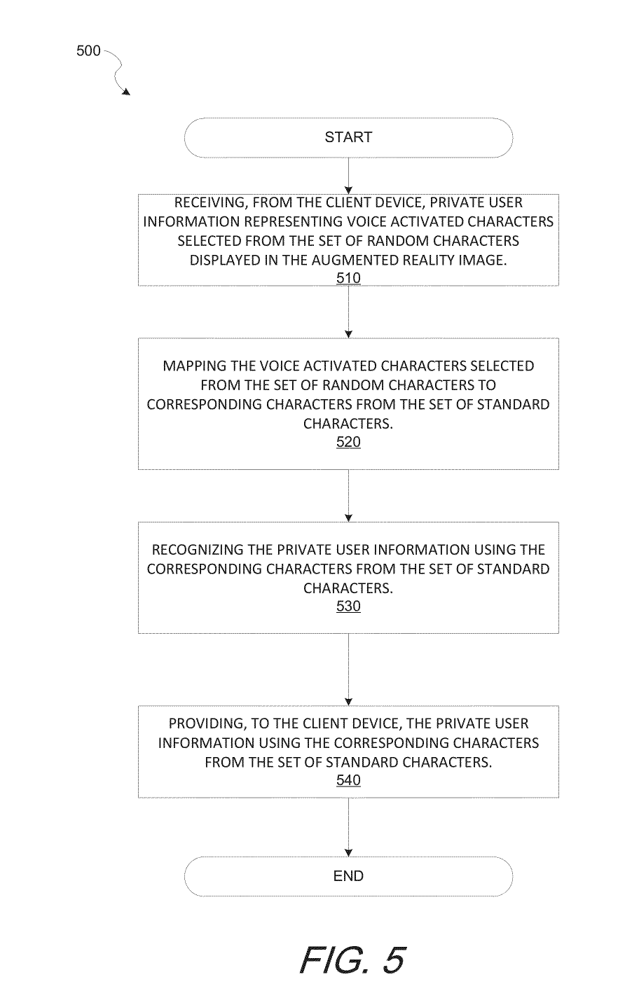

FIG. 5 is a flow diagram of a method 500 using voice input to provide private user information in accordance with an example embodiment. In one embodiment, the method comprises: at operation 510, receiving, from the client device, private user information representing spoken characters from the set of random characters displayed in an image; at operation 520, mapping spoken characters from the set of random characters to corresponding characters from the set of standard characters; at operation 530, recognizing the private user information using the corresponding characters from the set of standard characters; and at operation 540, providing, to the client device, the private user information using the corresponding characters from the set of standard characters. In alternative embodiments, operation 540 may be optional. For example embodiments, flow diagram 500 may be implemented using one or more modules from the random character visualization engine 218. For example, flow diagram 500 may be implemented using input module 310 at operation 510, mapping module 360 at operation 520, character recognition module 370 at operation 530, and display module 320 at operation 540.

The flow diagrams of methods 400 and 500 include several operations in the embodiments shown in FIGS. 4 and 5. For alternative embodiments, one or more of the operations shown in the flow diagrams 400 and 500 may not be performed, and in yet further embodiments, additional operations (not shown in flow diagrams 400 and 500) may be performed, in yet other embodiments, one or more of the operations may be combined into a single operation or subdivided into multiple operations, in other example embodiments, flow diagrams 400 and 500 may be combined to include one or more operations in the flow diagrams 400 and 500. For example, one or more operations in flow diagrams 400 and 500 may be combined to perform the generation of random characters, the visualization of random characters, receiving the voice input of the random characters, and the mapping and recognition of the random characters.

### Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Example Machine Architecture and Machine-Readable Medium

With reference to FIG. 7, an example embodiment extends to a machine in the example form of a computer system 700 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment or n-tier network, as a peer machine in a peer-to-peer or distributed) network environment or in a virtualized cloud computing environment. The machine may be a personal computer (PC), wearable computing device, a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 may include a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). In example embodiments, the computer system 700 also includes one or more of an alpha-numeric input device 712 (e.g., a keyboard), a user interface (UI) navigation device or cursor control device 714 (e.g., a mouse), a storage unit 716, a signal generation device 718 (e.g., a speaker), and a network interface device 720.

### Machine-Readable Storage Medium

The storage unit 716 includes a machine-readable storage medium 722 on which is stored one or more sets of instructions 724 and data structures (e.g., software instructions) embodying or used by any one or more of the methodologies or functions described herein. The instructions 724 may also reside, completely or at least partially, within the main memory 704 or within the processor 702 during execution thereof by the computer system 700, with the main memory 704 and the processor 702 also constituting machine-readable media.

While the machine-readable storage medium 722 is shown in an example embodiment to be a single medium, the term “machine-readable storage medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., Wi-Fi and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient tail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method, comprising:
receiving, from a client device, a request to communicate private user information;
generating a set of random characters in response to the request to communicate the private user information, at least one random character from the set of random characters corresponding to a character from a set of standard characters;
augmenting, using at least one processor, the set of standard characters with the set of random characters to create an image; and
providing image data to the client device to display the image.

2. The method of claim 1, wherein the image displays a mapping of the set of random characters to the set of standard characters.

3. The method of claim 1, wherein the image displays the set of random characters overlaying the set of standard characters.

4. The method of claim 1, wherein the step of augmenting, further comprises:
overlaying the set of random characters over the set of standard characters on a keyboard image.

5. The method of claim 1, wherein receiving, from the client device, the request to communicate the private user information, further comprises:
receiving, from a user, a voice action; and
converting the voice action to the request to communicate the private user information.

6. The method of claim 1, wherein generating the set of random characters in response to the request to communicate the private user information, further comprises:
mapping the set of random characters to the set of standard characters.

7. The method of claim 1, wherein generating the set of random characters in response to the request to communicate the private user information, further comprises:
generating at least one random character corresponding to each character in the set of standard characters, the at least one random character representing one or more letters, digits, colors, images or symbols.

8. The method of claim 7, wherein the set of standard characters represents characters available on a standard keyboard layout including one or more letters, digits, colors, images or symbols.

9. The method of claim 1, further comprising:
receiving, from the client device, private user information representing spoken characters from the set of random characters displayed in the image.

10. The method of claim 9, further comprising:
mapping the spoken characters from the set of random characters to corresponding characters from the set of standard characters;
recognizing the private user information using the corresponding characters from the set of standard characters; and
providing, to the client device, the private user information using the corresponding characters from the set of standard characters.

11. The method of claim 10, wherein the private user information represents password information or user account information for logging into an application accessible on the client device.

12. A system comprising:
at least one processor of a machine;
an input module configured to receive, from a client device, a request to communicate private user information using random characters;
a random character generating module configured to generate, using the at least one processor, a set of random characters in response to the request to communicate the private user information using random characters, at least one random character from the set of random characters corresponding to a character from a set of standard characters;
an augmented reality module configured to augment, using the at one least processor, the set of standard characters with the set of random characters to create an image; and
a display module configured to provide image data to the client device to display the image.

13. The system of claim 12, further comprising:
a mapping module configured to associate, using the at least one processor, the set of random characters with the set of standard characters.

14. The system of claim 12, further comprising:
a voice recognition module configured to
receive, from a user, a voice action; and
convert the voice action to the request to communicate the private user information using random characters.

15. The system of claim 12, wherein the image includes the set of random characters overlaying the set of standard characters.

16. The system of claim 12, wherein the input module is further configured to receive, from the client device, private user information representing spoken characters from the set of random characters displayed in the image.

17. The system of claim 116, further comprising a character recognition module further configured to map the spoken characters from the set of random characters to corresponding characters from the set of standard characters;
recognize the private user information using the corresponding characters from the set of standard characters; and
provide to the client device, the private user information using the corresponding characters from the set of standard characters.

18. The system of claim 17, wherein the private user information represents password information or user account information for logging into an application accessible on the client device.

19. The system of claim 12, wherein the client device does not include a keyboard like input device for receiving user input via physical keys.

20. A machine-readable medium comprising instructions, which when executed on a processor, cause the processor to perform a method comprising:
receiving, from a client device, a request to communicate private user information;
generating a set of random characters in response to the request to communicate private user information, at least one random character from the set of random characters corresponding to a character from a set of standard characters;
augmenting, using at least one processor, the set of standard characters with the set of random characters to create an image; and
providing image data to the client device to display the image.
